(19) United States
(12) Patent Application Publication
(10) Pub. No.: US 2017/0146790 A1
(43) Pub. Date: May 25, 2017

(54) IMAGE ACQUISITION DEVICE AND IMAGE FORMATION SYSTEM

(71) Applicant: Panasonic Intellectual Property Management Co., Ltd., Osaka (JP)

(72) Inventors: YUTAKA HIROSE, Kyoto (JP); KEISUKE YAZAWA, Chiba (JP); SHINZO KOYAMA, Osaka (JP); YOSHIHISA KATO, Hyogo (JP); HIDETO MOTOMURA, Kyoto (JP)

(21) Appl. No.: 15/426,125

(22) Filed: Feb. 7, 2017

Related U.S. Application Data
(63) Continuation of application No. PCT/JP2015/004065, filed on Aug. 17, 2015.

(30) Foreign Application Priority Data
Aug. 22, 2014 (JP) 2014-169406

(51) Int. Cl. G02B 21/36; G02B 21/26; G02B 21/06; G01N 21/84; H04N 5/349

(52) U.S. Cl. CPC G02B 21/367; G01N 21/84; H04N 5/349; G02B 21/06; G02B 21/26; G01N 2201/0627

(57) ABSTRACT

An image acquisition device includes an optical system, an illumination angle adjustment mechanism, and a stage. The optical system has a lens and a light source disposed in the focal plane of the lens, and generates a collimated illumination light. The illumination angle adjustment mechanism is configured so as to be able to change the irradiation direction of the illumination light with respect to an object. A module is detachably loaded on a stage. The module includes the object and an image sensor which are integrated such that the illumination light transmitted through the object is incident on the image sensor. The stage has a circuit for receiving an output of the image sensor in a state where the module is loaded on the stage.

### RELATED APPLICATIONS

This application is a Continuation of International Application No. PCT/JP2015/004065, filed on Aug. 17, 2015, which in turn claims priority from Japanese Patent Application No. 2014-169406, filed on Aug. 22, 2014, the contents of all of which are incorporated herein by reference in their entireties.

### BACKGROUND

1. Technical Field

The present disclosure relates to an image acquisition device and an image formation system.

2. Description of the Related Art

Conventionally, optical microscopes have been used to observe microstructures in biological tissues or the like. The optical microscope uses light transmitted through an observation object or light reflected by the object. An observer observes an image magnified by a lens. A digital microscope is also known that captures an image magnified with a microscope lens to display the image on a display. Using the digital microscope enables simultaneous observation by more than one person and observation in remote areas.

In recent years, techniques for observing the microstructure by using the contact image sensing (CIS) system have attracted attention. If the CIS system is adopted, the observation object is placed in proximity to the image pickup surface of the image sensor. As the image sensor, a two-dimensional image sensor in which a large number of photoelectric converters are arranged in rows and columns on the image pickup surface is generally used. The photoelectric converter is typically a photodiode formed on a semiconductor layer or a semiconductor substrate, and generates electric charges by receiving incident light.

The images acquired by the image sensor are defined by a large number of pixels. Each pixel is formed of a unit area including one photoelectric converter. Accordingly, resolution (definition) in the two-dimensional image sensor is generally dependent on the arrangement pitch or arrangement density of the photoelectric converters on the image pickup surface. In the present description, the resolution determined by the arrangement pitch of the photoelectric converters may be referred to as “intrinsic resolution” of the image sensor. Since the arrangement pitch of the individual photoelectric converter has been shorten close to the wavelength of visible light, it is difficult to further improve the intrinsic resolution.

A technique for achieving a resolution exceeding the intrinsic resolution of the image sensor has been proposed. Unexamined Japanese Patent Publication No. 62-137037 discloses a technique of forming an image of the object using a plurality of images obtained by shifting the image forming position of the object.

### SUMMARY

The present disclosure provides an image acquisition device and an image formation system capable of improving practicality of the high-resolution technique that achieves resolution exceeding the intrinsic resolution of the image sensor.

The following is provided as an illustrative exemplary embodiment of the present disclosure.

An image acquisition device includes: an optical system having a lens and a light source disposed in a focal plane of the lens, the optical system generating collimated illumination light; an illumination angle adjustment mechanism configured to be capable of changing an irradiation direction of the illumination light with respect to the object, and a stage on which a module is detachably loaded, the module including the object and an image sensor which are integrated such that the illumination light transmitted through the object is incident on the image sensor, the stage having a circuit for receiving an output of the image sensor in a state where the module is loaded on the stage. The above generic and specific aspect may be implemented in the form of a method, a system, or a computer program. Alternatively, the aspect may be implemented using a combination of a method, a system, a computer program, etc.

According to the present disclosure, the utility of high resolution technique for achieving resolution exceeding the intrinsic resolution of the image sensor is improved.

### BRIEF DESCRIPTION OF THE DRAWINGS

FIG. 1A is a plan view schematically showing a part of object;

FIG. 1B is a plan view schematically showing photodiodes relating to imaging extracted from an area shown in FIG. 1A;

FIG. 2A is a diagram schematically showing a direction of light beams transmitted through object and incident on photodiodes;

FIG. 2B is a plan view schematically showing an arrangement example of six photodiodes focused on;

FIG. 2C is a diagram schematically showing six pixels obtained by six photodiodes;

FIG. 3A is a diagram schematically showing a state in which light beams are incident from a second direction different from a first direction;

FIG. 3B is a plan view schematically showing the arrangement of six photodiodes focused on;

FIG. 3C is a diagram schematically showing six pixels obtained by six photodiodes;

FIG. 4A is a diagram schematically showing a state in which light beams are incident from a third direction different from the first direction and the second direction;

FIG. 4B is a plan view schematically showing the arrangement of six photodiodes focused on;

FIG. 4C is a diagram schematically showing six pixels obtained by six photodiodes;

FIG. 5A is a diagram schematically showing a state in which light beams are incident from a fourth direction different from the first direction, the second direction, and the third direction;

FIG. 5B is a plan view schematically showing the arrangement of six photodiodes focused on;

FIG. 5C is a diagram schematically showing six pixels obtained by six photodiodes;

FIG. 6 is a diagram illustrating high-resolution image made by synthesizing four sub-images;

FIG. 7 is a diagram schematically showing an irradiation direction adjusted such that light beams having passed through two adjacent areas of object are made incident on different photodiodes;

FIG. 8 is a diagram schematically showing an example of a cross-sectional structure of a module;

FIG. 9 is a diagram showing a schematic configuration of an image acquisition device according to an exemplary embodiment of the present disclosure;

FIG. 10 is a diagram showing an example of the configuration of an image acquisition device according to the exemplary embodiment of the present disclosure;

FIG. 11 is a diagram showing an example of a configuration of an illumination angle adjustment mechanism;

FIG. 12 is a diagram showing another example of the configuration of the illumination angle adjustment mechanism;

FIG. 13 is a diagram showing a configuration in which a plurality of light sources are arranged in a dispersed manner as a comparative example;

FIG. 14 is a diagram showing another example of the configuration of the image acquisition device according to the exemplary embodiment of the present disclosure;

FIG. 15 is a diagram showing still another example of the configuration of the illumination angle adjustment mechanism;

FIG. 16 is a diagram showing yet another example of the configuration of the illumination angle adjustment mechanism;

FIG. 17 is a diagram showing still another example of the configuration of the image acquisition device according to the exemplary embodiment of the present disclosure;

FIG. 18 is a diagram showing yet another example of the configuration of the illumination angle adjustment mechanism;

FIG. 19 is a schematic diagram showing an exemplary configuration of a circuit and a flow of signals of an image formation system according to the exemplary embodiment of the present disclosure;

FIG. 20 is a schematic diagram showing another example of the configuration of the image formation system;

FIG. 21 is a diagram showing a cross-sectional structure of a CCD image sensor, and an example of a distribution of relative transmittance of the object;

FIG. 22A is a diagram showing a cross-sectional structure of a back-irradiated type CMOS image sensor and an example of the distribution of relative transmittance of the object;

FIG. 22B is a diagram showing a cross-sectional structure of a back-irradiated type CMOS image sensor and an example of the distribution of relative transmittance of the object; and

FIG. 23 is a diagram showing a cross-sectional structure of a photoelectric conversion film stacked type image sensor, and an example of the distribution of relative transmittance of the object.

### DETAILED DESCRIPTION OF EMBODIMENT

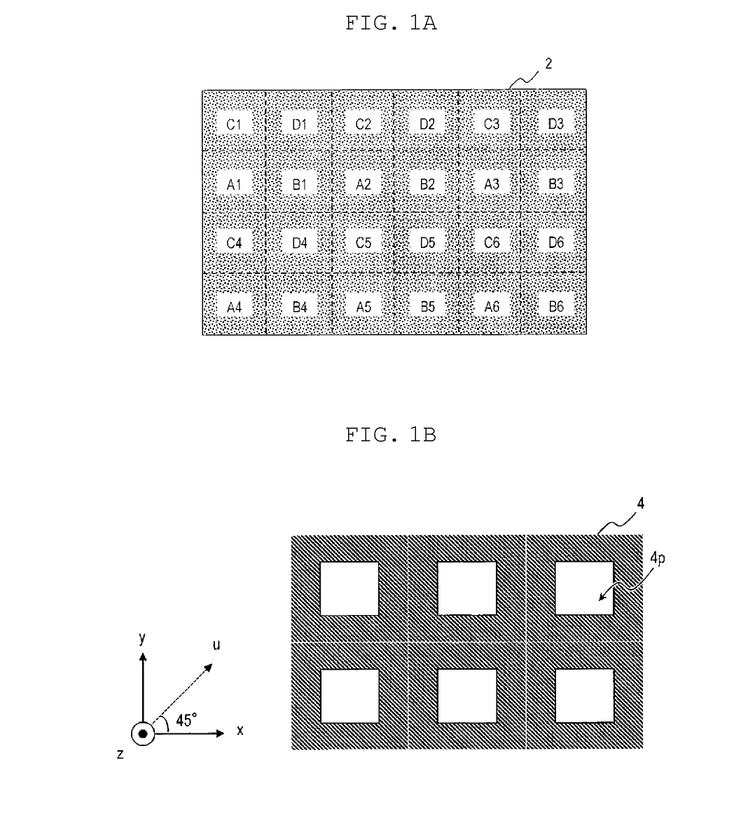

First, with reference to FIGS. 1A to 6, a principle of image pickup in an exemplary embodiment of the present disclosure will be described. In the exemplary embodiment of the present disclosure, by using a plurality of images obtained by performing image capturing a plurality of times while changing an irradiation angle of an illumination light, an image having higher resolution than that of each of the plurality of images (hereinafter, referred to as an “high resolution image”) is formed. Here, a description is given by way of an example of a charge coupled device (CCD) image sensor.

FIGS. 1A and 1B are referenced. FIG. 1A is a plan view schematically showing a part of object 2, and FIG. 1B is a plan view schematically showing photodiodes relating to imaging extracted from an area shown in FIG. 1A among photodiodes 4p of image sensor 4. In the example described here, six photodiodes 4p are illustrated in FIG. 1B. For reference, arrows indicating an x-direction, a y-direction and a z-direction orthogonal to each other are illustrated in FIG. 1B. The z-direction indicates the direction normal to the image pickup surface. In FIG. 1B, an arrow indicating a u-direction which is a direction rotated 45 degrees toward the y-axis from the x-axis in the xy plane is also illustrated. Also in other figures, the arrows indicating the x-direction, the y-direction, the z-direction or the u-direction are illustrated in some cases.

Components other than photodiodes 4p in image sensor 4 are covered with a light shielding layer. In FIG. 1B, the hatched area shows an area covered with the light shielding layer. An area (S2) of the light receiving surface of one photodiode on the image pickup surface of the CCD image sensor is smaller than an area (S1) of the unit area including the photodiode. A ratio of light receiving area S2 to area S1 (S2/S1) of the pixel is referred to as an “aperture ratio”. Here, a description will be made on the assumption that the aperture ratio is 25%.

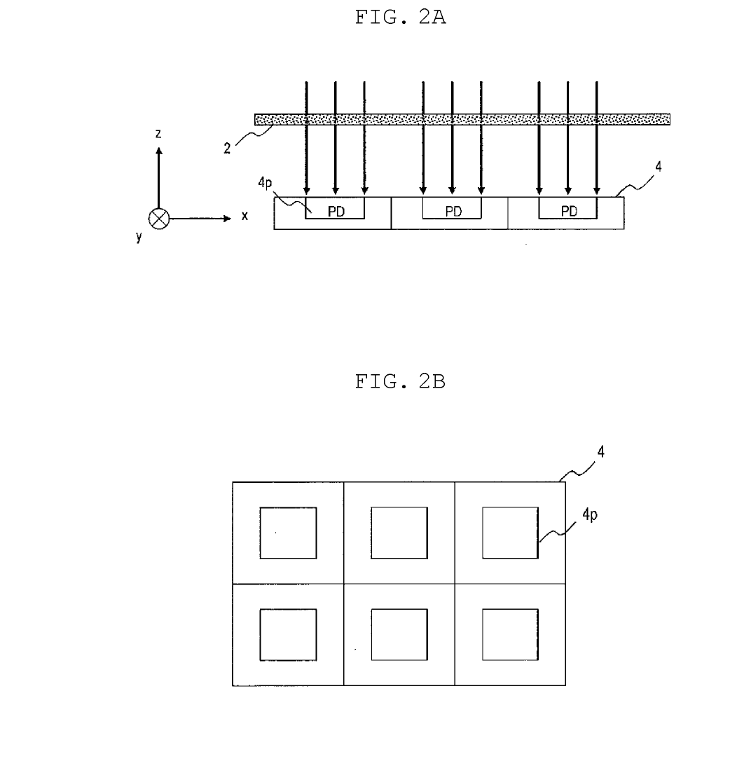

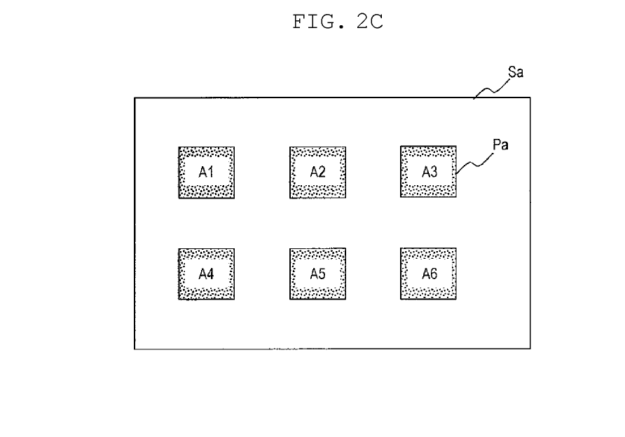

FIG. 2A schematically shows the direction of light beams incident on photodiode 4p after being transmitted through object 2. FIG. 2A shows a state in which light beams are incident from a direction (first direction) perpendicular to the image pickup surface. FIG. 2B is a plan view schematically illustrating an arrangement example of six photodiodes 4p focused on, and FIG. 2C is a view schematically showing six pixels Pa obtained by six photodiodes 4p. Each of the plurality of pixels Pa has a value (pixel value) representing the amount of light incident on each photodiode 4p. In this example, image Sa (first sub-image Sa) is formed from the pixels Pa in FIG. 2C. First sub-image Sa, for example, has information on areas A1, A2, A3, A4, A5 and A6 (see FIG. 1A) located directly above six photodiodes 4p shown in FIG. 2B in entire object 2.

As it can be seen from FIG. 2A, here, an image of object 2 is obtained using substantially parallel light beams transmitted through object 2. No lens for imaging is disposed between object 2 and image sensor 4. The distance from the image pickup surface of image sensor 4 to object 2 is typically 1 mm or less and may be set to about 1 μm, for example.

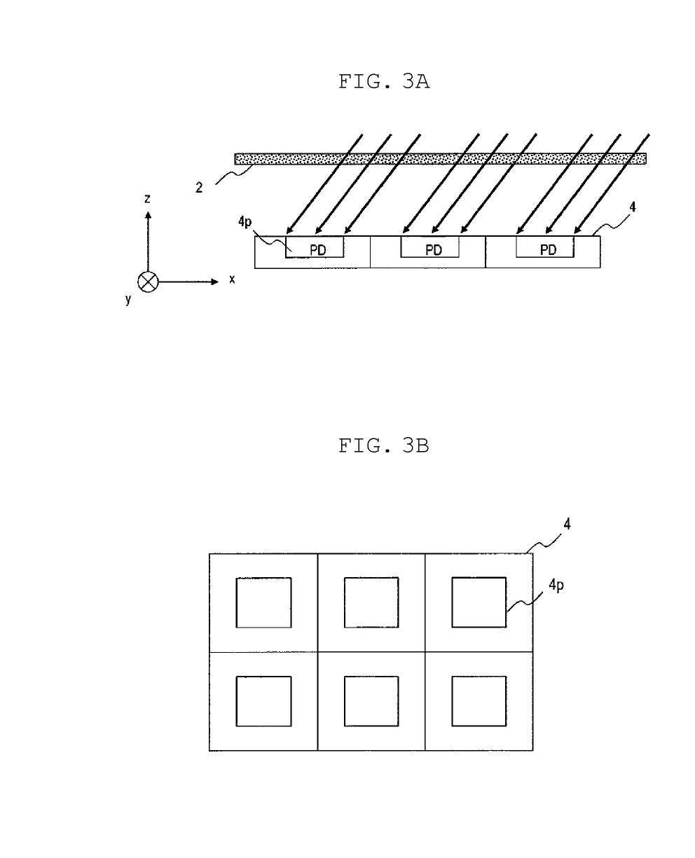

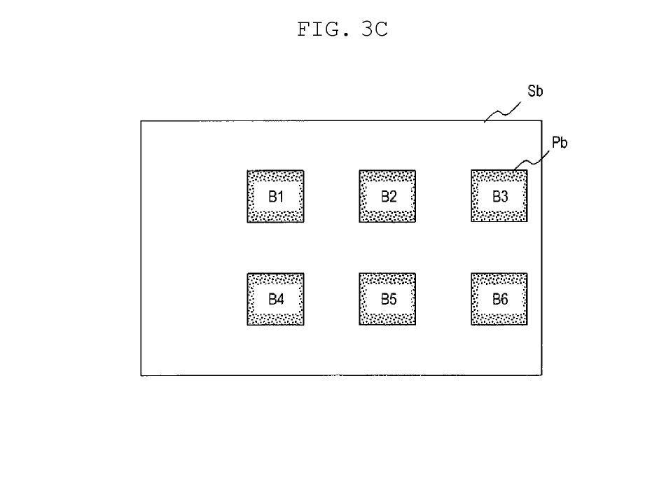

FIG. 3A shows a state in which light beams are incident from a second direction different from the first direction shown in FIG. 2A. FIG. 3B schematically shows the arrangement of six photodiodes 4p focused on, and FIG. 3C schematically shows six pixels Pb obtained by six photodiodes 4p. Image Sb (second sub-image Sb) is formed from pixels Pb in FIG. 3C. Second sub-image Sb has information on areas B1, B2, B3, B4, B5 and B6 (see FIG. 1A) in entire object 2, which are different from areas A1, A2, A3, A4, A5 and A6. As shown in FIG. 1A, area B1 is an area adjacent to the right side of area A1, for example.

As will be understood by comparing FIG. 2A with FIG. 3A, light beams having passed through different areas of object 2 can be made incident on photodiode 4p by setting the irradiating direction of the light beam appropriately with respect to object 2. As a result, first sub-image Sa and second sub-image Sb can include pixel information corresponding to the different positions in object 2.

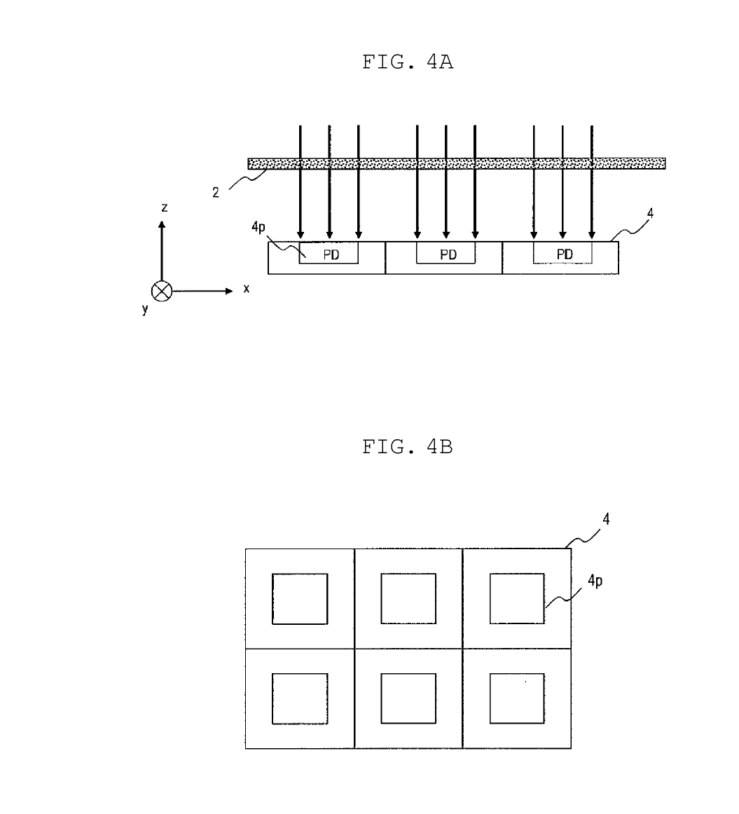

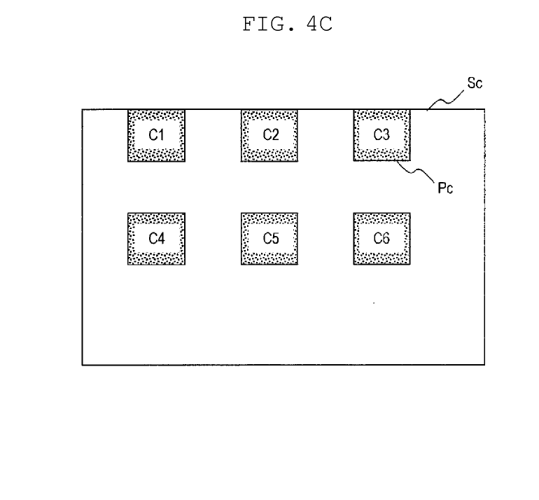

FIG. 4A illustrates a state in which light beams are incident from a third direction different from the first direction shown in FIG. 2A and the second direction shown in FIG. 3A. Light beams shown in FIG. 4A are inclined toward the y-direction with respect to the z-direction. FIG. 4B schematically shows an arrangement of six photodiodes 4p focused on, and FIG. 4C schematically shows six pixels Pc obtained by six photodiodes 4p. Image Sc (third sub-image Sc) is formed from pixels Pc in FIG. 4C. As shown in the figure, third sub-image Sc has information on areas C1, C2, C3, C4, C5 and C6 shown in FIG. 1A in entire object 2. As shown in FIG. 1A, here, area C1 is an area adjacent to the upper side of area A1, for example.

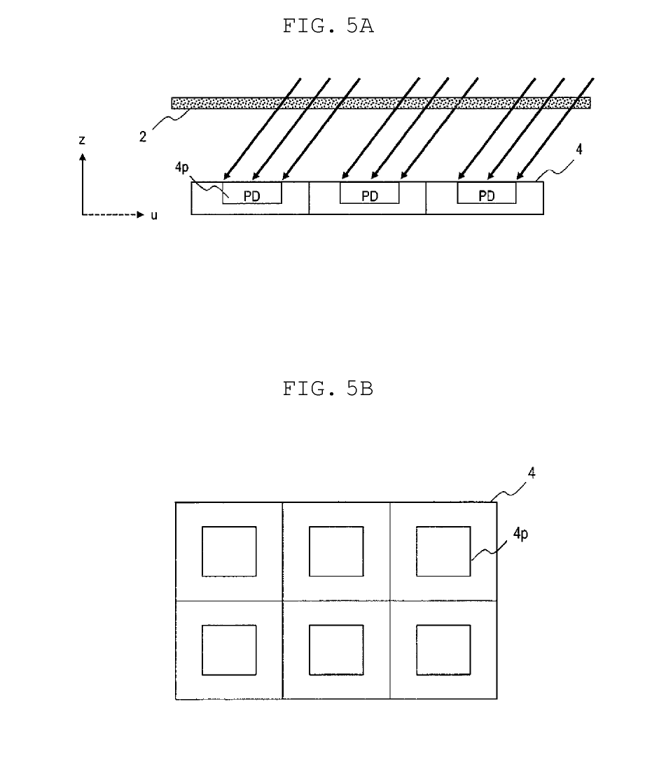

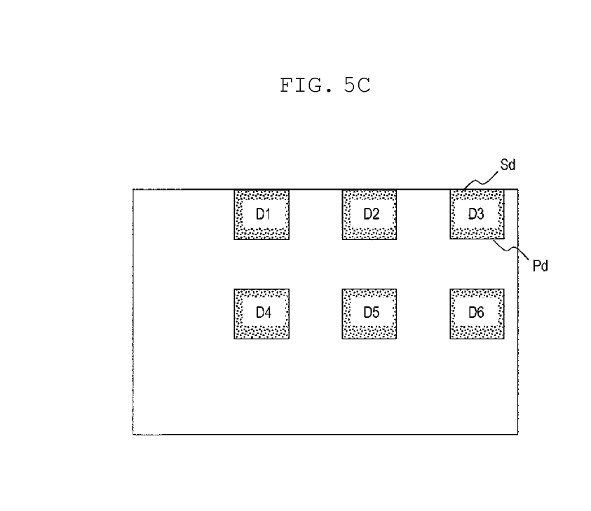

FIG. 5A shows a state in which incident light beams are made incident from a fourth direction different from the first direction shown in FIG. 2A, the second direction shown in FIG. 3A, and the third direction shown in FIG. 4A. The beams shown in FIG. 5A are inclined, with respect to the z-direction, toward the direction at an angle of 45 degrees with the x-axis in the xy plane. FIG. 5B schematically illustrates an arrangement of six photodiodes 4p focused on, and FIG. 5C schematically shows six pixels Pd obtained by six photodiodes 4p. Image Sd (fourth sub-image Sd) is formed from pixels Pd in FIG. 5C. Fourth sub-image Sd has information on areas D1, D2, D3, D4, D5 and D6 shown in FIG. 1A in entire object 2. As shown in FIG. 1A, here, area D1 is an area adjacent to the right side of area C1, for example.

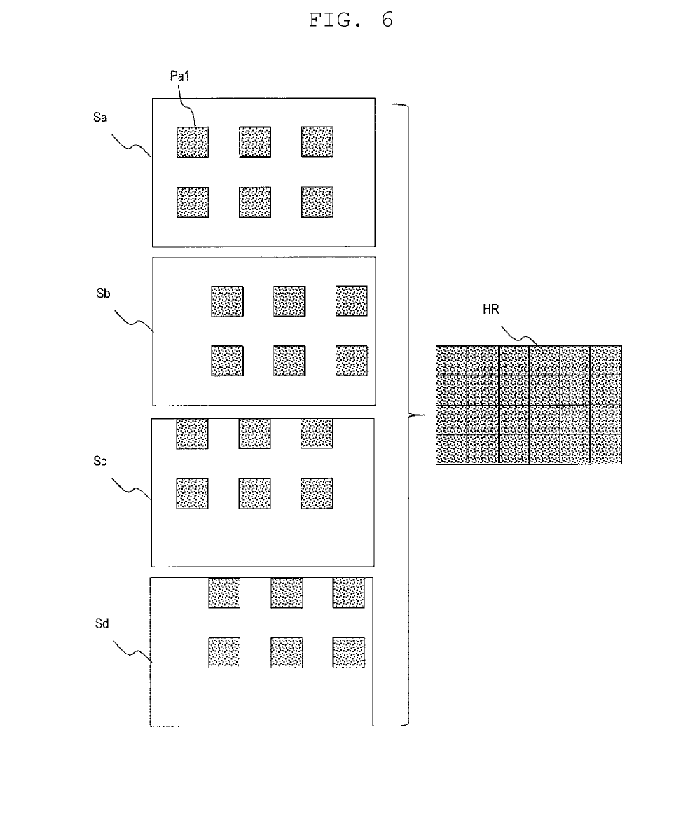

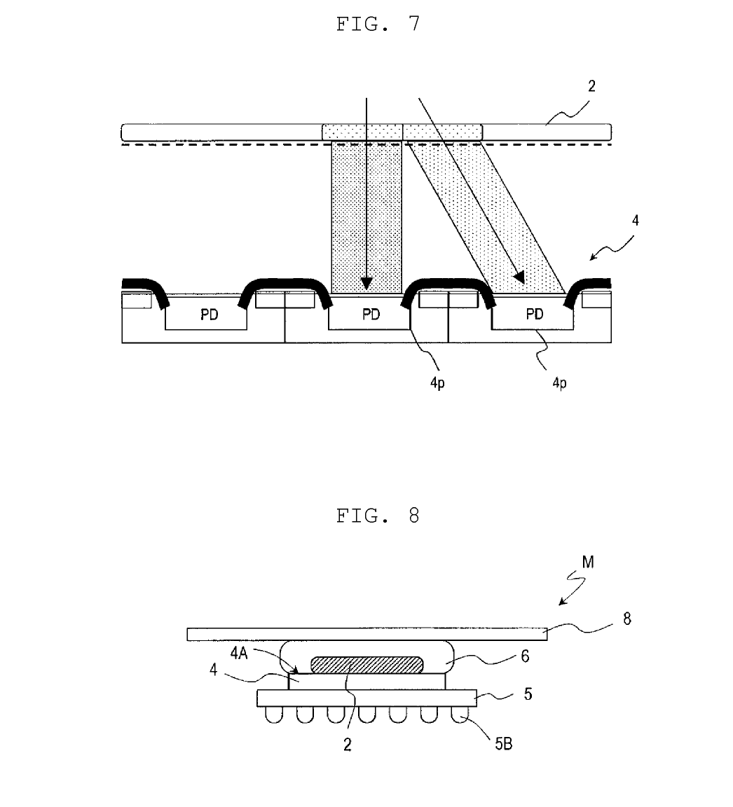

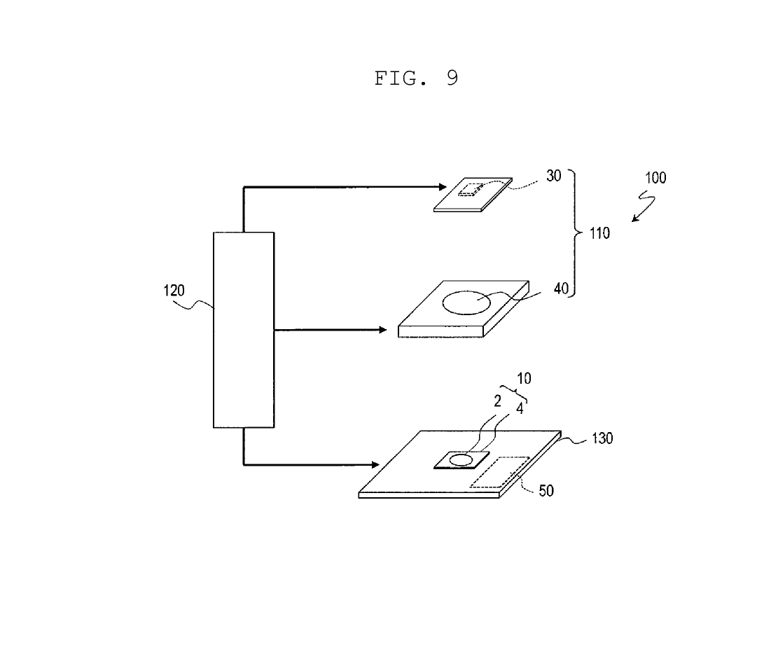

FIG. 6 shows a high-resolution image HR made by synthesizing four sub-images Sa, Sb, Sc and Sd. As shown in FIG. 6, a number of pixels or pixel density of high-resolution image HR is four times the number of pixels or pixel density of each of four sub-images Sa, Sb, Sc and Sd.

For example, attention is paid to blocks of areas A1, B1, C1 and D1 shown in FIG. 1A in object 2. As can be seen from the above description, pixel Pa1 of sub-image Sa shown in FIG. 6 has information on not the abovementioned entire blocks but only area A1. Thus, sub-image Sa can be said to be an image in which information on areas B1, C1 and D1 is lost. The resolution of each individual sub-image is equal to the intrinsic resolution of image sensor 4.

However, by using sub-images Sb, Sc and Sd having pixel information corresponding to the different positions in object 2, it is possible to complement the missing information in sub-image Sa and to form high-resolution image HR having information on the entire blocks as shown in FIG. 6. In this example, the resolution four times higher than the intrinsic resolution of image sensor 4 is obtained. The degree of the high resolution (super-resolution) is dependent on the aperture ratio of the image sensor. In this example, since the aperture ratio of image sensor 4 is 25%, resolution that is four times higher becomes possible by light irradiation from four different directions. When N is an integer equal to or more than 2 and the aperture ratio of image sensor 4 is approximately 1/N, high resolution of maximum N times becomes possible.

Thus, by performing imaging of an object by sequentially irradiating the object with parallel light from a plurality of different irradiation directions with respect to the object, the pixel information to be sampled “spatially” from the object can be increased. A high-resolution image with resolution higher than that of each of the plurality of sub-images can be formed by combining a plurality of obtained sub-images. Incidentally, in the above example, sub-images Sa, Sb, Sc and Sd shown in FIG. 6 have pixel information on different areas of object 2 and have no overlap. However, the sub-images may have an overlap between the different sub-images.

In the above example, light beams having passed through the two areas adjacent to each other in object 2 are both incident on the same photodiode. However, setting of the irradiation direction is not limited to this example. For example, as shown in FIG. 7, the irradiation direction may be adjusted so that the light beams having passed through the two adjacent areas in object 2 are incident on different photodiodes respectively. When the relative position of an area where the light beam passes in the object to the photodiode which the transmitted light beam enters is known, high-resolution images can be formed. The irradiation direction is not limited to the first to the fourth directions described with reference to FIGS. 2A to 5A.

Next, a configuration of a module used in the exemplary embodiment of the present disclosure will be described. In the exemplary embodiment of the present disclosure, a module having a structure in which the object and the image sensor are integrated is used.

FIG. 8 schematically shows an example of the cross-sectional structure of the module. In module M shown in FIG. 8, object 2 is disposed on image pickup surface 4A side of image sensor 4. In the configuration illustrated in FIG. 8, object 2 covered with encapsulating medium 6 is sandwiched between image sensor 4 and transparent plate (typically a glass plate) 8. A common glass slide can be used as transparent plate 8, for example. In the configuration illustrated in FIG. 8, image sensor 4 is fixed to package 5. Package 5 has back surface electrode 5B on the side opposite to transparent plate 8. Back surface electrode 5B is electrically connected to image sensor 4 via a wiring pattern (not shown) formed in package 5. That is, an output of image sensor 4 can be taken out through back surface electrode 5B.

Object 2 can be a slice of biological tissue (typically, tens of microns or less in thickness). A module having a thin piece of biological tissue as object 2 may be utilized in a pathology diagnosis. As shown in FIG. 8, module M has an image sensor for acquiring an image of the object differently from a preparation for supporting the object (slice of biological tissue typically) in the observation with an optical microscope. Such a module may be referred to as an “electronic preparation”. By using module M in which object 2 and image sensor 4 are integrated, the advantage of fixing the positioning between object 2 and image sensor 4 is obtained.

When executing the acquisition of an image of object 2 using module M, object 2 is irradiated with illumination light through transparent plate 8. Illumination light transmitted through object 2 enters image sensor 4. By acquiring a plurality of different images while changing the angle during irradiation, an image with high resolution than that of each of these images can be formed.

The present disclosure provides an image acquisition device (digitizer) and an image formation system each capable of improving the utility of the high resolution technique for achieving resolution exceeding the intrinsic resolution of the image sensor. Before describing the exemplary embodiment of the present disclosure in detail, an outline of the exemplary embodiment of the present disclosure will be described first.

Image acquisition device which is one aspect of the present disclosure includes an optical system, an illumination angle adjustment mechanism, and a stage. The optical system has a lens and a light source disposed in the focal plane of the lens. The optical system generates collimated illumination light. The illumination angle adjustment mechanism is configured to be capable of changing the irradiating direction of the illumination light with respect to the object into a plurality of different directions. The stage is a stage on which a module is detachably loaded, the module including the object and an image sensor which are integrated such that the illumination light transmitted through the object is incident on the image sensor. The stage has a circuit that receives an output of the image sensor in a state where the module is loaded on the stage.

In an aspect, the illumination angle adjustment mechanism has a mechanism capable of independently rotating at least one of orientations of the stage and the light source around two axes which are orthogonal to each other.

In an aspect, the illumination angle adjustment mechanism includes a goniometer mechanism for changing at least one of an attitude of the stage and an attitude of the light source orientation.

In an aspect, the illumination angle adjustment mechanism includes a mechanism for rotating at least one of the stage and the light source with respect to a rotation axis passing through a center of the stage.

In an aspect, the illumination angle adjustment mechanism includes a slide mechanism for parallel shifting of at least one of the stage, the light source, and the lens.

In an aspect, the light source includes at least one of sets each having a plurality of light emitting elements for emitting light of different wavelength bands from each other.

In an aspect, the light source has a plurality of sets each having a plurality of light emitting elements. These plurality of sets are arranged at positions different from each other.

In an aspect, the lens is an achromatic lens.

In an aspect, the stage includes a first circuit board including a first processing circuit for converting an output of the image sensor into a digital signal and for outputting the digital signal.

In an aspect, the stage has a second circuit board including a second processing circuit for generating a control signal of the image sensor, and the second circuit board is integrally coupled to the first circuit board.

The image acquisition device according to an aspect further includes a third processing circuit configured to successively perform an averaging process for an image signal representing an image of the object corresponding to the irradiation direction, the image signal being obtained in every time when the irradiation direction is changed.

The image formation system according to another aspect of the present disclosure includes an image acquisition device according to any of the above aspects, and an image processing device. The image processing device forms a high resolution image of the object with resolution higher than that of each of a plurality of images of the object which are obtained by changing the irradiation direction of the illumination light. The image processing device forms the high resolution image by synthesizing the plurality of images.

Hereinafter, with reference to the accompanying drawings, the exemplary embodiment of the present disclosure will be described in detail. In the following description, components having substantially the same function are denoted by the same reference numerals, and the description thereof may be omitted.

### <Image Acquisition Device>

FIG. 9 shows a schematic configuration of an image acquisition device according to the exemplary embodiment of the present disclosure. Image acquisition device 100 shown in FIG. 9 includes optical system 110 for generating illumination light, and stage 130 configured such that module 10 is loaded detachably. Stage 130 may have an attachment portion in which at least a part of module 10 can be inserted or a fixture such as a clip for holding module 10. Module 10 is fixed to stage 130 by being loaded on stage 130. As module 10, a module having the same configuration as module M which has been described with reference to FIG. 8 may be used. That is, module 10 may have a structure in which object 2 and image sensor 4 are integrated. In a state in which module 10 is loaded on stage 130, object 2 and image sensor 4 of module 10 have an arrangement such that the illumination light transmitted through object 2 enters image sensor 4. In the illustrated example, the image pickup surface of image sensor 4 is facing to optical system 110 positioned above module 10. The arrangements of optical system 110, object 2, and image sensor 4 are not limited to the illustrated example.

Optical system 110 includes light source 30 and lens 40. Light source 30 is disposed in the focal plane of lens 40. Illumination light generated by optical system 110 is collimated parallel light. Illumination light generated by optical system 110 is incident on the object.

Stage 130 has circuit 50 which receives an output of image sensor 4. The electrical connection between circuit 50 and image sensor 4 is established, for example, via back electrode 5B (see FIG. 8) by loading module 10 on stage 130.

Image acquisition device 100 further includes illumination angle adjustment mechanism 120. As described later in detail, illumination angle adjustment mechanism 120 is a mechanism for changing the radiation direction of the illumination light with respect to object 2 into a plurality of different directions. Thus, a plurality of sub-images to be used to form the high resolution image can be obtained by executing image capturing of object 2 while changing the irradiation direction successively by using image acquisition device 100.

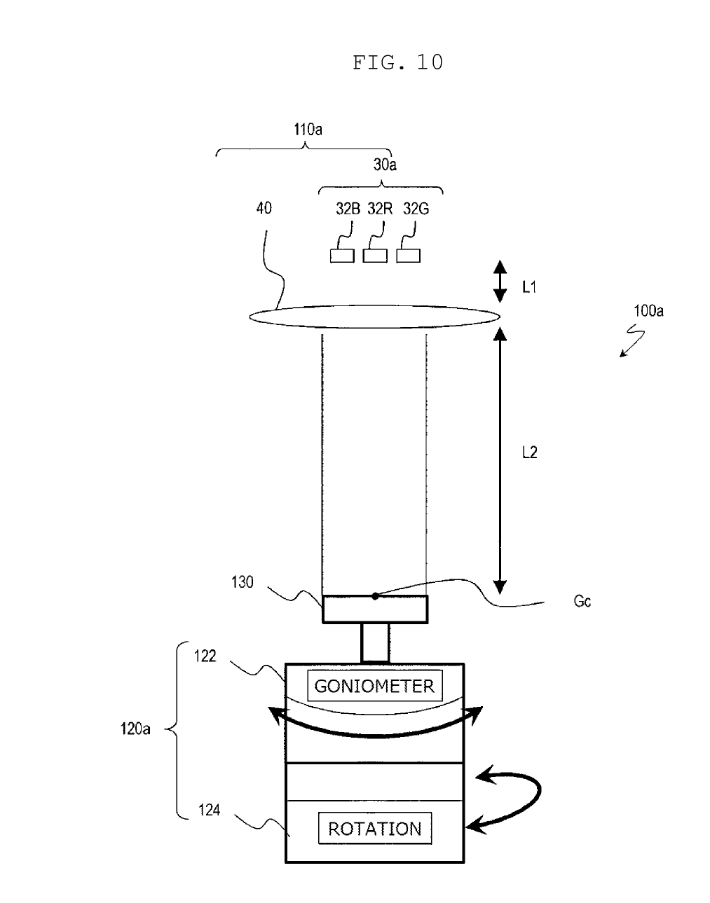

FIG. 10 shows an example of the configuration of an image acquisition device according to the exemplary embodiment of the present disclosure. In the configuration illustrated in FIG. 10, light source 30a has three LED chips 32B, 32R, 32G each having a peak in a different wavelength band. The space between adjacent LED chips is about 100 μm, for example, and when being arranged in close proximity in this manner, the plurality of light emitting elements can be considered to be a point light source. Three LED chips 32B, 32R, 32G may be LED chips that emit blue, red, and green light respectively. When using a plurality of light emitting elements for emitting light of different colors, an achromatic lens is used as lens 40.

A plurality of sub-images can be obtained for each color by using a plurality of light emitting elements for emitting light of colors different from each other and by emitting light of different colors in each irradiation direction in a time sequential manner, for example. In the case of using three LED chips 32B, 32R, 32G, a set of blue sub-images, set of the red sub-images, and set of green sub-images are obtained. A high-resolution color image can be formed by using the sets of the acquired sub-images. For example, in the case of pathological diagnosis, more useful information about the presence or absence of a lesion or the like can be obtained by utilizing the high-resolution color images.

A number of light emitting elements included in light source 30 may be one. Different color illumination light from each other may be obtained in a time sequential manner by using a white LED chip as light source 30 and by placing a color filter in the optical path. Further, an image sensor for color imaging may be used as image sensor 4. However, from the viewpoint of suppressing reduction in amount of light incident on the photoelectric converter of the image sensor, a configuration that does not place a color filter is advantageous as shown in FIG. 10. In the case of using light of a plurality of different colors, lens 40 may not be achromatic lens when the wavelength band is narrow. Light source 30 is not limited to LEDs, and may be incandescent bulbs, laser devices, fiber lasers, discharge tubes or the like. Light emitted from light source 30 is not limited to visible light, and may be ultraviolet light, infrared light or the like.

Image acquisition device 100a shown in FIG. 10 changes the irradiation angle of the illumination light with respect to object 2 by changing the attitude of stage 130. The irradiation angle of the illumination light with respect to object 2 is represented by a set of an angle (zenith angle) between the normal line to the image pickup surface of image sensor 4 and the light beam incident on object 2 and an angle (azimuth) between the reference direction set on the image pickup surface and projection of the light beam incident on the image pickup surface, for example. In the example shown in the figure, illumination angle adjustment mechanism 120a is provided with goniometer mechanism 122 to tilt stage 130 with respect to a reference plane (typically horizontal plane), and rotation mechanism 124 to rotate stage 130 with respect to a rotation axis (in this case a vertical axis) passing through the center of stage 130. Goniometer center Gc of goniometer mechanism 122 is located in a center of the object (not shown). Goniometer mechanism 122 is configured so as to be able to tilt stage 130 in a range of about ±20 degrees, for example, with respect to the reference plane. As described above, the module is fixed to stage 130 in a state of being loaded on stage 130. Accordingly, illumination light can be made incident on the object from any irradiation direction by combining the rotation in the vertical plane by goniometer mechanism 122 and the rotation around the vertical axis by rotation mechanism 124.

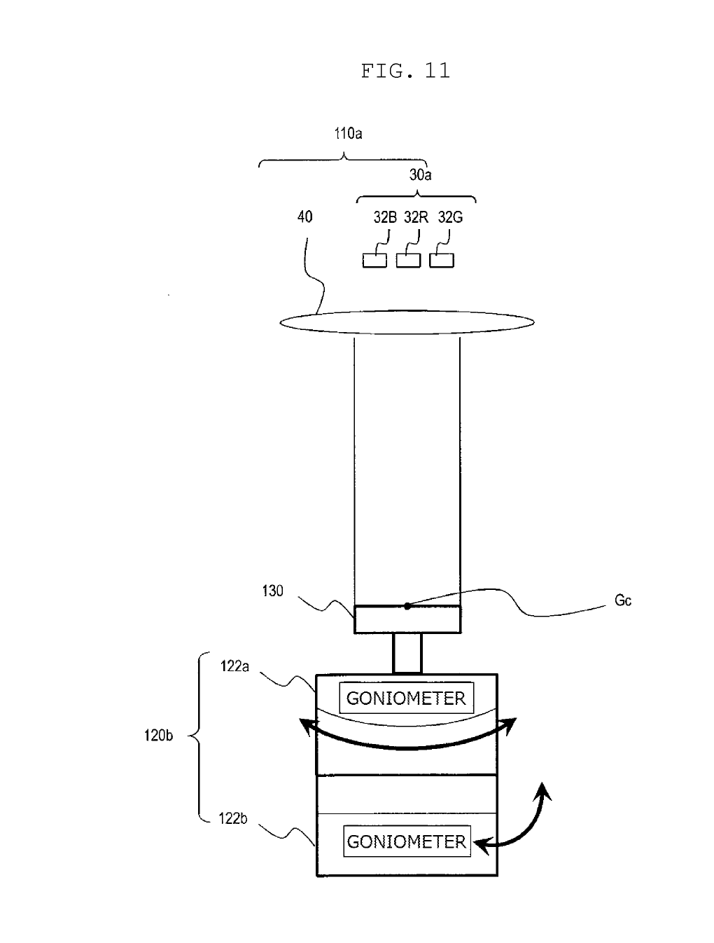

The mechanism for changing the attitude of stage 130 is not limited to the combination of goniometric mechanism 122 and rotation mechanism 124. In the configuration illustrated in FIG. 11, illumination angle adjustment mechanism 120b includes a set of two goniometer mechanisms 122a and 122b which can rotate the orientation of the object in vertical planes orthogonal to each other. Goniometer center Gc of goniometer mechanism 122a and 122b are located in the center of the object (not shown). Also with such a configuration, illumination light can be made incident on the object from any illumination direction.

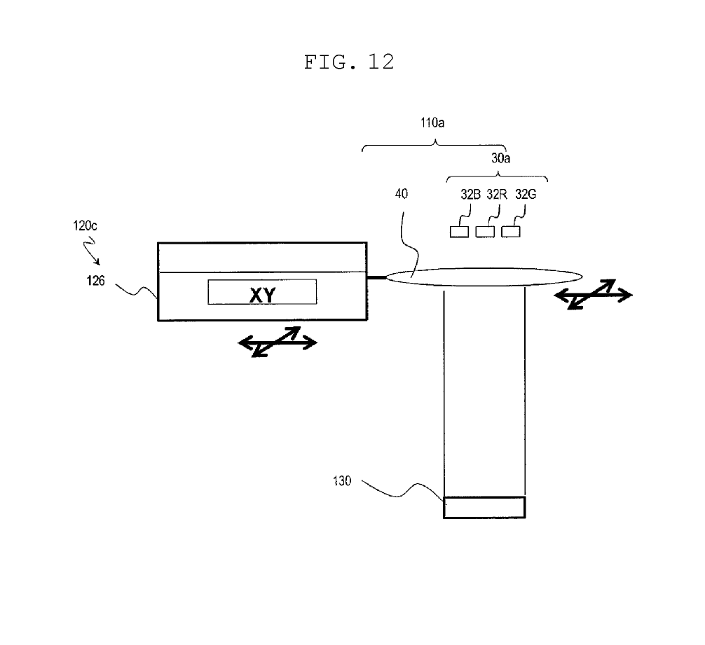

FIG. 12 shows another example of the configuration of the illumination angle adjustment mechanism. Illumination angle adjustment mechanism 120c shown in FIG. 12 has slide mechanism 126 for parallel shifting of lens 40. By moving lens 40 over an optional distance in the X-axis direction and/or Y-axis direction in a reference plane, the irradiation angle of the illumination light can be changed with respect to the object. According to the configuration illustrated in FIG. 12, it is not necessary to change the attitude of stage 130, and thus a more compact image acquisition device can be attained even when the light source and the image sensor are linearly arranged.

In the exemplary embodiment of the present disclosure, a lens for collimating the light beam emitted from the light source is disposed on the optical path connecting the light source and the object on the stage. This can reduce size and/or weight of the image acquisition device compared with the case of arranging a plurality of light sources in a simply dispersed manner.

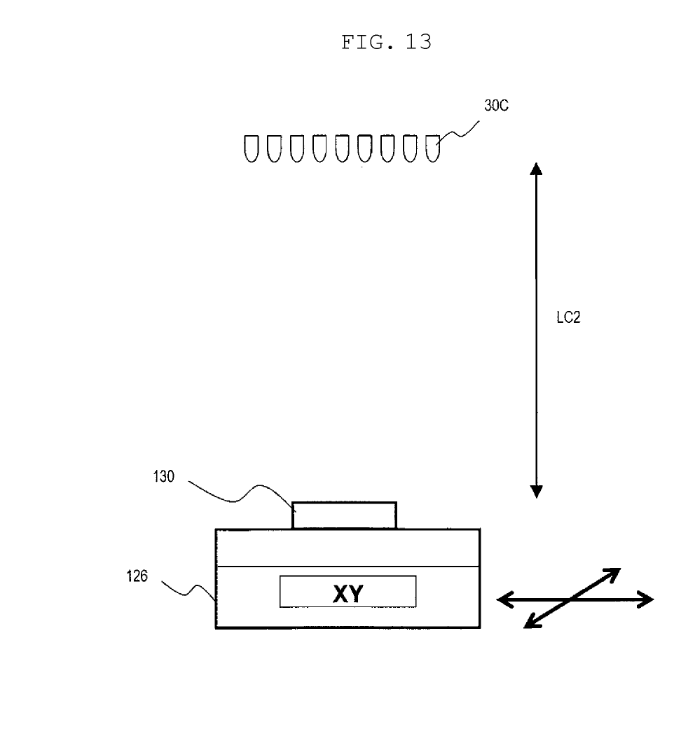

FIG. 13 shows, as a comparative example, a configuration in which a plurality of light sources are arranged in a dispersed manner. In the illustrated example, a plurality of shell type light emitting diodes (LEDs) 30C are arranged in a dispersed manner, and no lens is disposed between shell type LEDs 30C and stage 130. A number of shell type LEDs 30C is 25, for example. The irradiation direction can be successively changed by arranging the plurality of light emitting elements in a dispersed manner and by sequentially turns on the light-emitting element. Alternatively, by moving stage 130 in parallel to the reference plane, an irradiating direction can be successively changed. The distance through which the stage is movable by slide mechanism 126 may be approximately 25 mm, for example.

However, in this configuration, the illumination light cannot be considered to be parallel light unless the light emitting element and the image sensor are sufficiently separated away. In the configuration shown in FIG. 13, distance LC2 between LEDs 30C and the image sensor (not shown) may be on the order of 500 mm. Further, according to the studies of the inventors of the present disclosure, in the configuration shown in FIG. 13, the shading correction for the sub-images is necessary to form a high resolution image from a plurality of sub-images obtained by sequentially switching LEDs 30C that emits light.

In contrast, in the exemplary embodiment of the present disclosure, optical system 110 for generating the illumination light includes lens 40, and light source 30 is disposed in the focal plane of lens 40. In the optical system 110a illustrated in FIG. 10, distance L2 between lens 40 and the image sensor (not shown) may be on the order of 150 mm. Further, the distance L1 between light source 30a and lens 40 may be approximately 70 mm. Therefore, even when a light source and the image sensor are linearly arranged, a size of the image acquisition device can be reduced as compared with the case of arranging a plurality of light emitting elements in a dispersed manner.

Further, according to the study of the inventors of present disclosure, substantially uniform illuminance distribution can be achieved by generating the illumination light collimated by optical system 110 including lens 40. For example, in an area of 30 millimeters square, a change in the illuminance in the vicinity of an area end with respect to the illuminance of an area center may be about 0.5%. Although the illumination light having the light beam parallelism of about several degrees requires shading correction of the sub-images, the light beam parallelism is 0.7 degree or less in the configuration illustrated in FIG. 10, and thus the shading correction is not required. Here, the light beam parallelism is a parameter that is obtained by measuring the illuminance distribution while changing the distance between the light source and the irradiated surface and that is determined from the relationship between the distance from the light source and the illuminance distribution, representing the spread degree of the light beam.

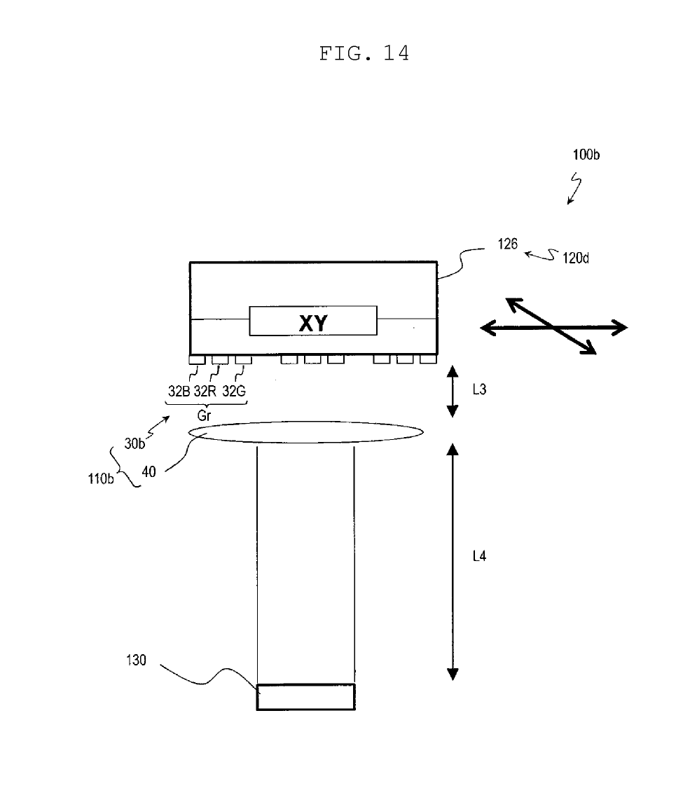

FIG. 14 shows another example of the configuration of the image acquisition device according to the exemplary embodiment of the present disclosure. Stage 130 is fixed in image acquisition device 100b shown in FIG. 14. In the configuration illustrated in FIG. 14, illumination angle adjustment mechanism 120d includes slide mechanism 126 for parallel shifting of light source 30b in the focal plane of lens 40. Moving light source 30b through an optional distance in the direction of the X-axis and/or Y-axis in the focal plane of lens 40 can change the irradiation angle of the illumination light with respect to the object. The distance through which light source 30b is movable by slide mechanism 126 may be approximately 15 mm, for example. Also by adding slide mechanism 126 to lens 40, configurations may be employed in which lens 40 and light source 30b are capable of parallel shifting independently. Stage 130 may be moved parallel to the reference plane.

In the configuration illustrated in FIG. 14, light source 30b in optical system 110b have set Gr of three LED chips 32B, 32R, 32G each having a peak in a different wavelength band similarly to light source 30a shown in FIG. 10. In the configuration illustrated in FIG. 14, light source 30b includes nine sets of LED chips. Here, sets Gr of the LED chips are arranged in a 3×3 matrix. In this configuration, by switching the LED chips that emits light sequentially, the irradiation angle of the illumination light can be changed with respect to the object. By arranging a plurality of sets of light emitting elements for emitting light of different colors in different positions from each other, various combinations of light colors and irradiation directions are achieved and thus more flexible operation is possible.

In the configuration illustrated in FIG. 14, light emitted from a position deviated from the optical axis of the lens is used. Therefore, there are cases where shading correction is needed. On the other hand, since it is not necessary to change the attitude of stage 130, a more compact image acquisition device can be achieved even when the light source and the image sensor are linearly arranged. In the configuration as shown in FIG. 14, distance L4 between lens 40 and the image sensor (not shown) is approximately 30 mm, for example, and distance L3 between light source 30b and lens 40 is approximately 20 mm, for example.

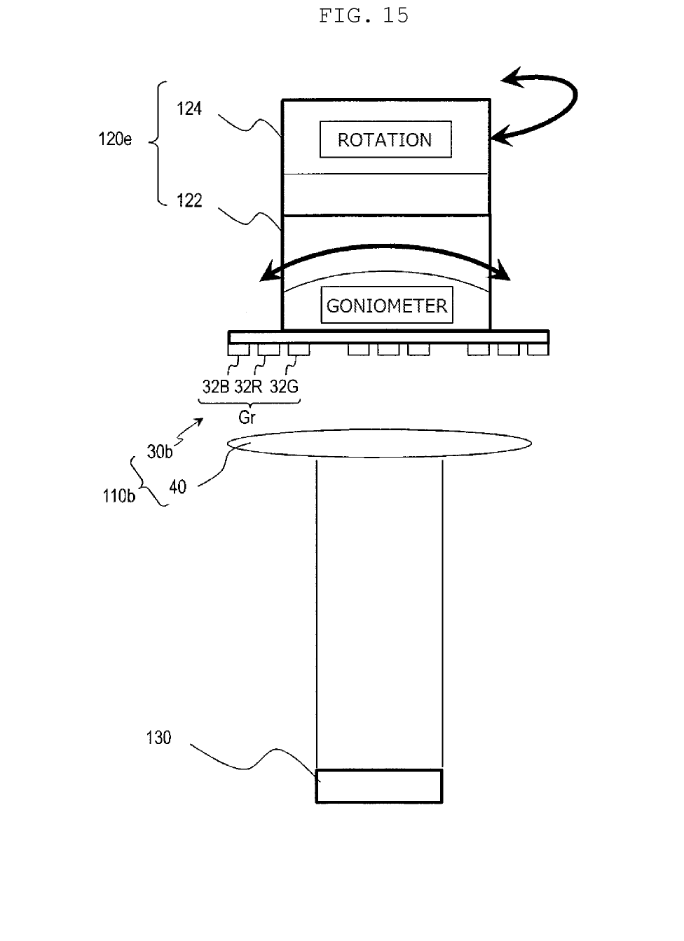

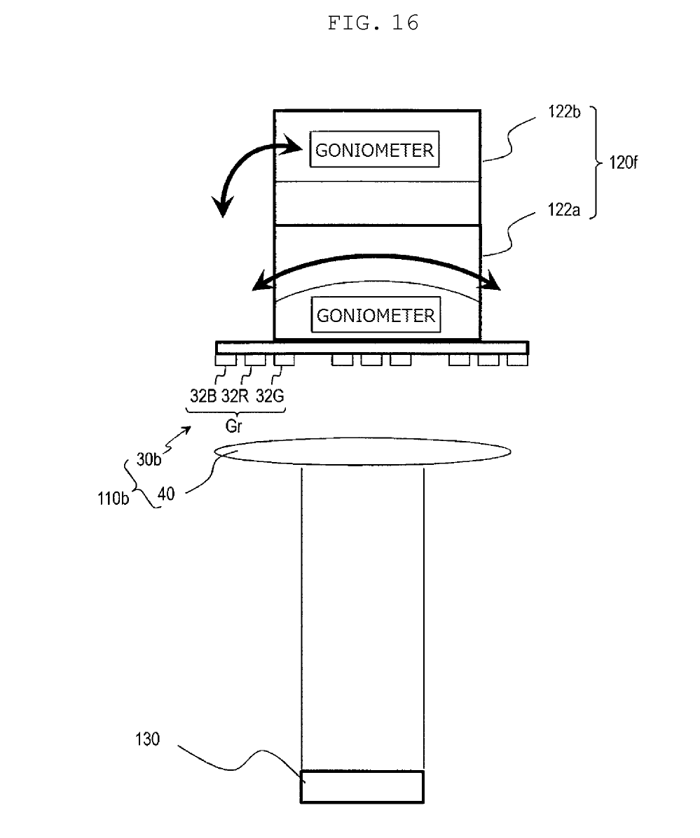

FIG. 15 shows another example of the configuration of the illumination angle adjustment mechanism. Illumination angle adjustment mechanism 120e shown in FIG. 15 includes goniometer mechanism 122 for changing the orientation of light source 30b, and rotation mechanism 124 for rotating light source 30b with respect to a rotation axis passing through the center of stage 130 (here, a vertical axis). With such a configuration, the irradiation direction can be changed with respect to the object. Further, as shown in FIG. 16, illumination angle adjustment mechanism 120f having two goniometer mechanisms 122a and 122b may be applied. An adjustment mechanism may be added to at least one of lens 40 and light source 30 for movement in parallel to the optical axis. Light source 30 only needs to be located in the focal plane of lens 40 at the time of acquisition of the sub-image.

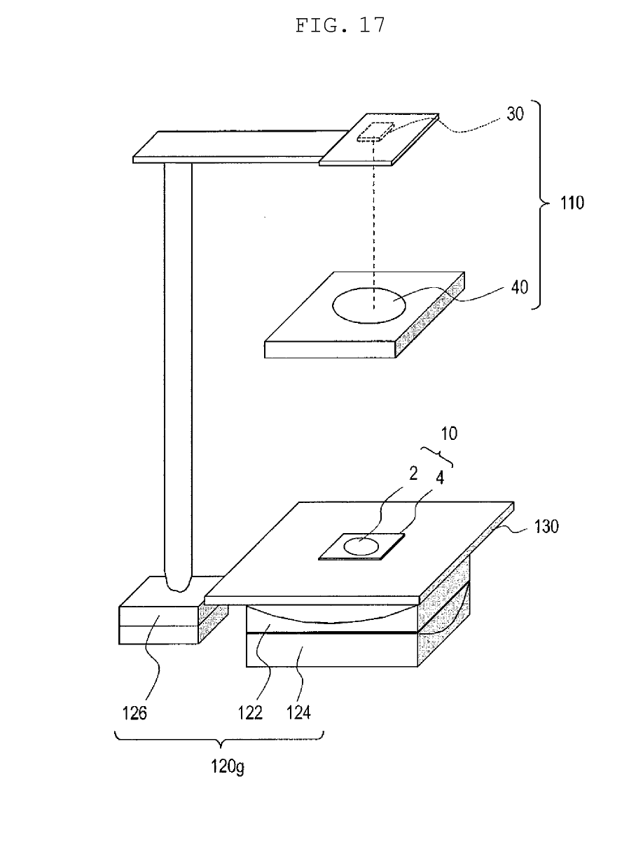

The illumination angle adjustment mechanism may further include a mechanism to vary the attitude of stage 130. As shown in FIG. 17, for example, an illumination angle adjustment mechanism 120g with slide mechanism 126 for parallel shifting of light source 30 in the focal plane of lens 40, goniometer mechanism 122 for tilting stage 130, and rotation mechanism 124 for rotating stage 130 may also be used. As the parameters increase, a range of selection for the optimal irradiation directions increases.

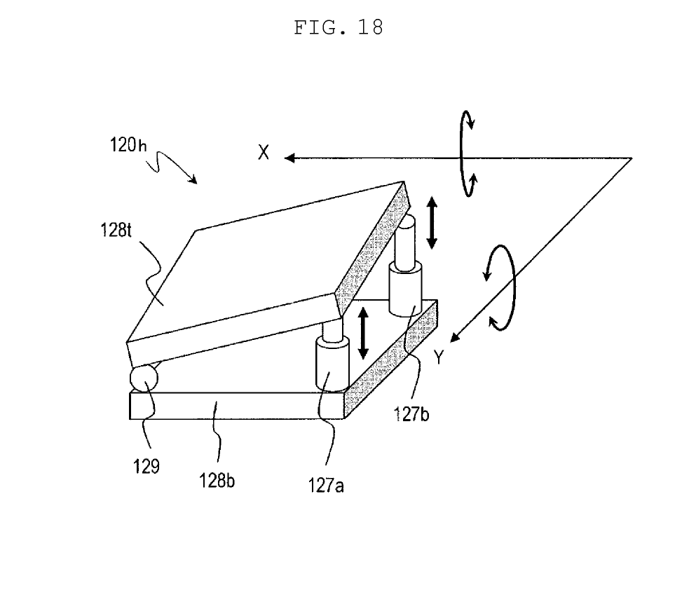

A configuration shown in FIG. 18 may be employed, instead of the combination of goniometer mechanism 122 and rotation mechanism 124 (see FIGS. 10 and 15), or the combination of two goniometer mechanisms 122a and 122b (see FIGS. 11 and 16). Illumination angle adjustment mechanism 120h shown in FIG. 18 includes top plate 128t and bottom plate 128b connected by joint 129. An example of joint 129 is a universal joint or a ball joint with two rotary axes orthogonal to each other.

In the illustrated example, each of top plate 128t and bottom plate 128b has a rectangular shape when viewed from a direction perpendicular to the top surface, and joint 129 is disposed near one of four vertices of the rectangle. Further, as illustrated in the figure, linear actuators 127a and 127b are disposed near two of the other three vertices of the rectangle of bottom plate 128b. Top plate 128t is supported on bottom plate 128b by joint 129, and linear actuators 127a and 127b. For each of linear actuators 127a and 127b, a combination of a ball screw and a motor or a piezoelectric actuator can be used, for example.

In the example shown in the figure, by operating linear actuators 127a and 127b independently, heights of two points on top plate 128t (positions corresponding to two of the four vertices of the rectangle) can be changed independently. For example, by arranging stage 130 on top plate 128t, stage 130 can be rotated independently with respect to two orthogonal axes (X-axis and Y-axis shown in FIG. 18). Light source 30 may be disposed on top plate 128t. Also with such a configuration, illumination light can be made incident on the object from any irradiation direction.

### <Image Formation System>

Next, the image formation system according to the exemplary embodiment of the present disclosure will be described.

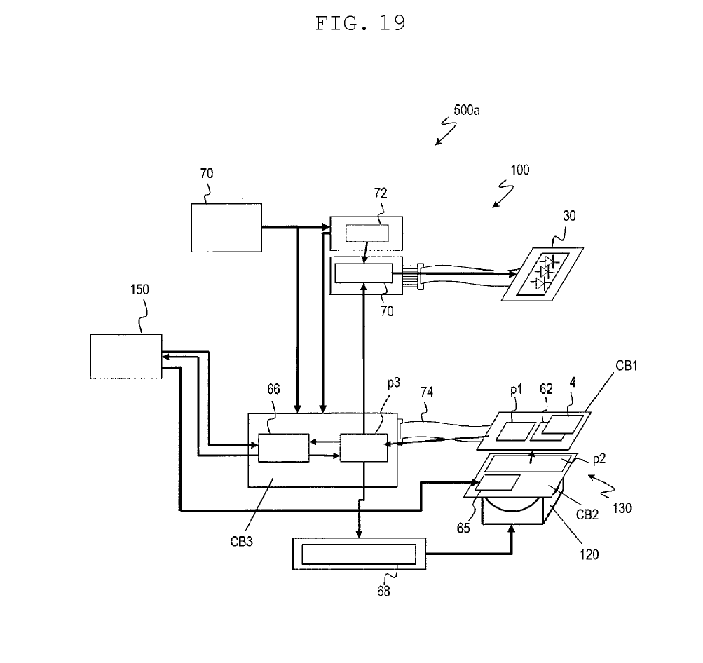

FIG. 19 shows an exemplary configuration of a circuit and the flow of signals of the image formation system according to the exemplary embodiment of the present disclosure. Image formation system 500a shown in FIG. 19 includes image acquisition device 100 and image processing device 150. FIG. 19 shows a state where module 10 is mounted on the stage. However, the illustration of object 2 and illustration of stage 130 in module 10 are omitted. The arrows in FIG. 19 schematically show the flow of signals or electric power.

In image formation system 500a, the data of the sub-image acquired by image acquisition device 100 are sent to image processing device 150. Image processing device 150 forms a high resolution image of the object having resolution higher than that of each of the sub-images by using the principles described with reference to FIGS. 1A to 6 and by synthesizing the plurality of sub-images.

Image processing device 150 may be constituted by a general purpose or special purpose computer. Image processing device 150 may be a device different from image acquisition device 100 and may be a part of image acquisition device 100. Image processing device 150 may be a device having a function as a controller for supplying various commands for controlling the operation of each unit in image acquisition device 100. Here, image processing device 150 is described as an example of a configuration that also has a function as a controller. As a matter of course, a system may have a configuration such that image processing device 150 and the controller are separate devices. For example, the controller and image processing device 150 may be connected to each other via a network such as the Internet. Image processing device 150 installed in a location different from the location of the controller may be configured so as to perform the formation of high resolution images by receiving data of the sub-images from the controller via the network.

In the example shown in FIG. 19, image acquisition device 100 includes circuit board CB1 having circuit 50 (not shown in FIG. 19) that receives the output of image sensor 4, circuit board CB2 and circuit board CB3 for providing timing signals to image sensor 4. Here, circuit board CB1 and circuit board CB2 are disposed within stage 130.

In the configuration illustrated in FIG. 19, circuit board CB1 includes processing circuit p1 and analog front end (AFE) 62. In the example described here, the output of image sensor 4 is sent to processing circuit p1 through AFE 62. Processing circuit p1 may be constituted of a field programmable gate array (FPGA), an application specific standard produce (ASSP), application specific integrated circuits (ASIC), a digital signal processor (DSP) or the like. Circuit board CB2 includes processing circuit p2, and input-output unit 65 which is connectable to image processing device 150. Processing circuit p2 may include the FPGA, ASSP, ASIC, DSP, and a microcomputer, etc. Circuit board CB3 includes processing circuit p3, and input-output unit 66 that is connectable to image processing device 150. Processing circuit p3 may be constituted of the FPGA, ASSP, ASIC, DSP and the like. Circuit board CB2 and circuit board CB3, and image processing device 150 may be connected by a USB, for example.

Image processing device 150 supplies a command for executing a desired operation to image acquisition device 100. For example, commands relating to the operation of light source 30 and stage 130 of image acquisition device 100 are sent to image acquisition device 100 such that the acquisition of the sub-image is performed under an appropriate irradiation angle condition. Processing circuit p3 of circuit board CB3 generates a control signal for controlling stage controller 68 on the basis of the received commands. Stage controller 68 operates illumination angle adjustment mechanism 120 on the basis of the control signal. In the illustrated example, a combination of two goniometer mechanisms is used as illumination angle adjustment mechanism 120. The control of stage controller 68 changes the attitude of stage 130. With the change in the attitude of stage 130, the attitude of image sensor 4 on stage 130 is changed. Further, processing circuit p3 generates a signal for controlling light source drive circuit 70, and controls lighting and switching-off of light source 30. In the illustrated example, electric power for driving light source 30 is supplied from power source 70 via DC-DC converter 72.

In the configuration illustrated in FIG. 19, processing circuit p2 of circuit board CB2 receives information about driving of image sensor 4 from image processing device 150. Processing circuit p2 generates a timing signal or the like on the basis of the information relating to the driving received from the image processing device 150. Image sensor 4 of the module in the state of being loaded on stage 130 performs image capturing of the object on the basis of a control signal sent from processing circuit p2. An image signal acquired by image sensor 4 and representing the image of the object is sent to processing circuit p1 of circuit board CB1.

Processing circuit p1 may be a processing circuit configured to output digital signals. Digital signals from processing circuit p1 are transferred to processing circuit p3 of circuit board CB3 by low voltage differential signaling (LVDS), for example. Incidentally, AFE 62 may have an AD conversion circuit. When AFE 62 is of an AD conversion circuit built-in type like this, processing circuit p1 performs timing adjustment and data format conversion for transferring information to processing circuit p3. In the illustrated example, circuit board CB1 and circuit board CB3 are connected by cable 74 which corresponds to the LVDS. As described above, here, circuit board CB1 is disposed within stage 130. By sending the output of image sensor 4 to the outside of circuit board CB1 in the form of a digital signal, noises may be reduced as compared with the case of transmitting the output of image sensor 4 in the form of an analog signal.

Here, circuit board CB2 is also disposed in stage 130. Circuit board CB2 may be integrally coupled to circuit board CB1. For example, the attitudes of circuit board CB1 and circuit board CB2 may vary in accordance with the change in the attitude of stage 130. By separating the circuit board including an analog signal circuit from another circuit board and by placing the circuit board in stage 130, an advantage of attainment of a small sized movable stage can be obtained.

Data of the obtained sub-images are transmitted to image processing device 150 via circuit board CB3. Thereafter, by repeating the image capturing of the object by operating illumination angle adjustment mechanism 120, a plurality of sub-images can be obtained.

Incidentally, every time an image signal representing an image of the object are obtained corresponding to a plurality of different directions, averaging processing of the image signal may be performed sequentially. By executing the averaging process every time the image signal corresponding to the different illumination directions is obtained, noises may further be reduced in the sub-image. The averaging process may be executed by processing circuit p3 of circuit board CB3, for example. The processing circuit for executing an averaging process is not limited to processing circuit p3 of circuit board CB3, and averaging processing only needs to be performed in any of the processing circuits in image acquisition device 100.

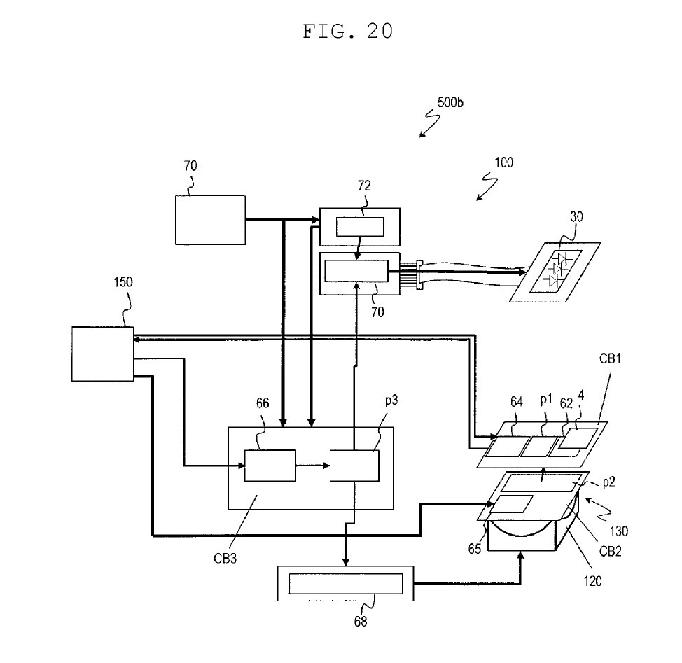

FIG. 20 shows another example of the configuration of an image formation system. The difference of image formation system 500b shown in FIG. 20 from image formation system 500a of FIG. 19 is that circuit board CB1 has input-output unit 64 and that circuit board CB1 and image processing device 150 are connected to each other. Circuit board CB1 and image processing device 150 may be connected by a USB, for example.

In the configuration illustrated in FIG. 20, data of the obtained sub-images are sent from circuit board CB1 to image processing device 150 without passing through circuit board CB3. Image processing device 150 may give a command relating to drive timing of image sensor 4 to processing circuit p1 of circuit board CB1. By connecting circuit board CB1 and image processing device 150 without an intervention of circuit board CB3, the strip-shaped cable can be omitted. As a result, it becomes easier to adopt a configuration that changes the attitude of circuit board CB1 together with the attitude of stage 130.

As described above, by relatively changing the arrangement of image sensor 4 with respect to a light beam emitted from light source 30, object 2 is irradiated from a plurality of angles, and the plurality of sub-images corresponding to the different irradiation directions can be obtained. In the above, a configuration in which light source 30, lens 40 and object 2 are linearly arranged is illustrated. However, the arrangement of light source 30, lens 40 and object 2 is not limited to the examples described so far, and object 2 may be irradiated with illumination light by changing the direction of the light beam by using a mirror, for example. According to such a configuration, the image acquisition device can become more compact.

Incidentally, image sensor 4 is not limited to the CCD image sensor, and may be a complementary metal-oxide semiconductor (CMOS) image sensor or other image sensors (as one example, a photoelectric conversion film stacked type image sensor to be described below). The CCD image sensor and CMOS image sensor can be of a front-irradiated type or a back-irradiated type. Hereinafter, the relationship between the element structure of the image sensor and the light incident on the photodiode of the image sensor will be described.

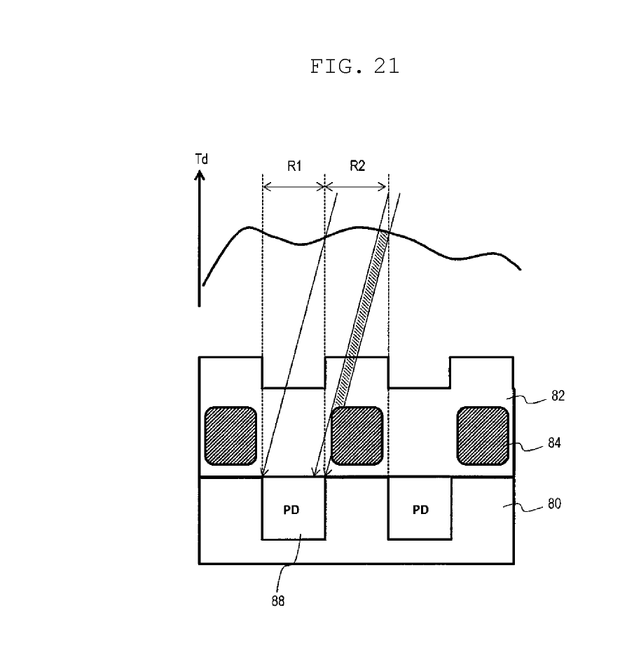

FIG. 21 shows a cross-sectional structure of a CCD image sensor, and an example of the distribution of relative transmittance Td of the object. As shown in FIG. 21, the CCD image sensor generally includes substrate 80, insulating layer 82 on substrate 80, and wiring 84 arranged in the insulating layer 82. A plurality of photodiodes 88 are formed on substrate 80. A light shielding layer (not shown in FIG. 21) are formed on wiring 84. Here, the illustration of a transistor or the like is omitted. A transistor or the like is not shown also in the following drawings. Note that, roughly speaking, the cross-sectional structure near the photodiode of the front-irradiated type CMOS image sensor is substantially similar to the cross-sectional structure near the photodiode of the CCD image sensor. Therefore, here illustration and description of the cross-sectional structure of the front-irradiated type CMOS image sensor are omitted.

As shown in FIG. 21, if the illumination light is incident from the direction normal to the image pickup surface, the irradiation light transmitted through area R1 in the object located immediately above photodiode 88 enters photodiode 88. On the other hand, the irradiation light transmitted through area R2 in the object located immediately above the light-shielding layer on wiring 84 is incident on the light-shielding area of the image sensor (area where the light-shielding film is formed). Therefore, when the light is irradiated from the direction normal to the image pickup surface, an image showing area R1 in the object located immediately above photodiode 88 is obtained.

To obtain an image showing an area directly above the light shielding film, irradiation only has to be made from a direction inclined relative to the direction normal to the image pickup surface such that light transmitted through area R2 is incident on photodiode 88. At this time, part of the light transmitted through area R2 may be blocked by wiring 84 depending on the irradiation direction. In the illustrated example, light beam passing through the portion indicated by the hatching does not reach photodiode 88. Therefore, there are cases where the pixel value reduces somewhat in the oblique incidence. However, since all of the transmitted light is not intercepted, formation of high-resolution image using the sub-images obtained at this time is possible.

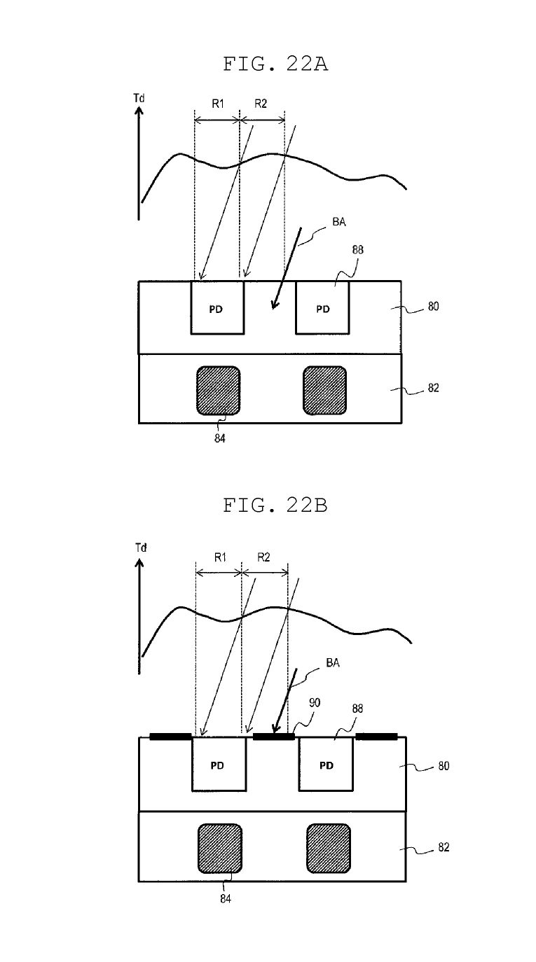

FIGS. 22A and 22B show a cross-sectional structure of a back-irradiated type CMOS image sensor and an example of the distribution of relative transmittance Td of the object. As shown in FIG. 22A, the transmitted light is not blocked by wiring 84 in the back-irradiated type CMOS image sensor even in the case of the oblique incidence. However, since light transmitted through areas in the object other than the area intended to be subjected to image capturing (light schematically shown by thick arrow BA in FIG. 22A and FIG. 22B to be described later) is incident on substrate 80, noise occurs and the quality of the sub-image may be deteriorated. Such deterioration can be reduced by forming light shielding layer 90 on areas other than the area where the photodiode is formed in the substrate as shown in FIG. 22B.

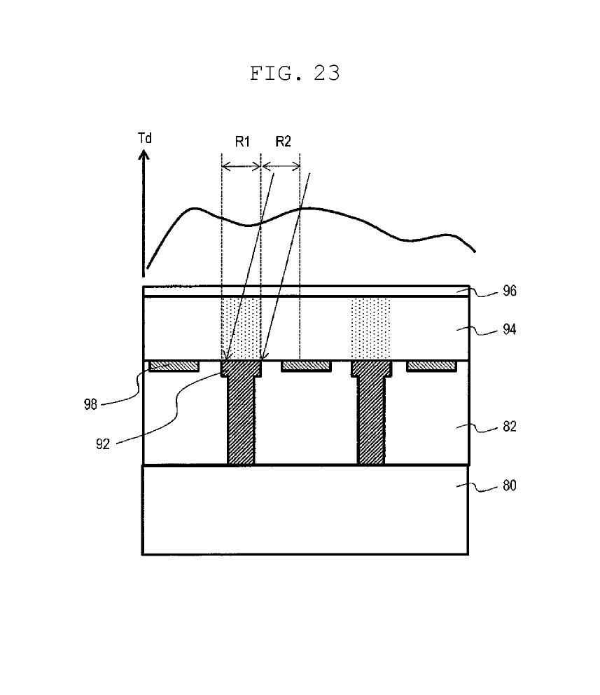

FIG. 23 shows a cross-sectional structure of an image sensor (hereinafter, referred to as “photoelectric conversion film stacked type image sensor”) having a photoelectric conversion film formed of an organic material or an inorganic material and an example of the distribution of relative transmittance Td of the object.

As shown in FIG. 23, a photoelectric conversion film stacked type image sensor mainly includes substrate 80, insulating layer 82 provided with a plurality of pixel electrodes, photoelectric conversion film 94 on insulating layer 82, and transparent electrode 96 on photoelectric conversion film 94. As illustrated in the figure, photoelectric conversion film 94 for performing photoelectric conversion is formed above substrate 80 (e.g., a semiconductor substrate) instead of the photodiode formed on a semiconductor substrate in the photoelectric conversion film stacked type image sensor. Photoelectric conversion film 94 and transparent electrode 96 are typically formed over the entire image pickup surface. Here, the protection film for protecting photoelectric conversion film 94 is not shown.

In the photoelectric conversion film stacked type image sensor, electric charges (electrons or holes) generated by photoelectric conversion of incident light in photoelectric conversion film 94 are collected by pixel electrode 92. Accordingly, a value indicating amount of light incident on the photoelectric conversion film 94 is obtained. Therefore, it can be said that the unit area including one pixel electrode 92 corresponds to one pixel on the image pickup surface in the photoelectric conversion film stacked type image sensor. In the photoelectric conversion film stacked type image sensor, no transmitted light is blocked by wiring even in the case of oblique incidence similarly to the back-irradiated type CMOS image sensor.

As described with reference to FIGS. 1A to 6, a plurality of sub-images showing images based on different parts of the object are used in the formation of high-resolution images. However, since photoelectric conversion film 94 is formed over the entire image pickup surface in a typical photoelectric conversion film stacked type image sensor, the photoelectric conversion can occur in photoelectric conversion film 94 even by light that is transmitted through the area other than the desired area of the object even in the case of vertical incidence, for example. When extra electrons or holes generated in this case is drawn to pixel electrode 92, there is fear that appropriate sub-images cannot be obtained. Therefore, it is useful to selectively draw charges generated in the area where pixel electrode 92 and transparent electrode 96 overlap each other (hatched area in FIG. 23) to pixel electrode 92.

In the configuration illustrated in FIG. 23, dummy electrode 98 is disposed in the pixel in correspondence with each pixel electrode 92. A suitable potential difference is applied between pixel electrode 92 and dummy electrode 98 at the time of acquisition of the image of the object. Thus, the electric charge generated in areas other than the area where pixel electrode 92 and transparent electrode 96 overlap each other can be brought into dummy electrodes 98, and an electric charge generated in the area where pixel electrode 92 and transparent electrode 96 overlap each other can be selectively brought into pixel electrode 92. Also by the patterning of transparent electrode 96 or photoelectric conversion film 94, the same effect can be obtained. In such a configuration, the ratio of area S3 of pixel electrode 92 to area S1 of the pixel (S3/S1) can be said to correspond to the “aperture ratio”.

As previously described, in the case where N is an integer equal to or more than 2, high resolution up to N times becomes possible when the aperture ratio of image sensor 4 is equal to approximately 1/N. In other words, when the aperture ratio is smaller, the technique is more advantageous for high resolution. In the photoelectric conversion film stacked type image sensor, the ratio (S3/S1) corresponding to the aperture ratio can be adjusted by adjusting area S3 of pixel electrode 92. This ratio (S3/S1) is set within the range of 10% to 50%, for example. The photoelectric conversion film stacked type image sensor within the range of the ratio (S3/S1) described above can be used for super-resolution.

As can be seen from FIGS. 21 and 22B, the surfaces of a CCD image sensor and front-irradiated type CMOS image sensor facing the object are not flat. For example, there is a level difference on its surface in a CCD image sensor. Further, in the back-irradiated type CMOS image sensor, it is necessary to provide a patterned light shielding layer on the image pickup surface in order to obtain the sub-image for forming a high resolution image, and therefore, the surface facing the object is not flat.

In contrast, the image pickup surface of the photoelectric conversion film stacked type image sensor is a substantially flat surface, as can be seen from FIG. 23. Therefore, even when an object is disposed on the image pickup surface, deformation of the object due to the shape of the image pickup surface hardly occurs. In other words, by obtaining the sub-images by using a photoelectric conversion film stacked type image sensor, a more detailed structure of the object can be observed.

The above described various aspects in the present description can be combined with each other as long as no conflict arises.

According to the present disclosure, a more compact image acquisition device can be provided. The image acquisition device or image formation system according to the exemplary embodiment of the present disclosure can facilitate the application of high resolution technique for achieving resolution exceeding the intrinsic resolution of the image sensor. High-resolution images provide useful information in the case of pathological diagnosis, for example.

What is claimed is:

1. An image acquisition device comprising:
an optical system that has a lens and a light source disposed in a focal plane of the lens, the optical system generating collimated illumination light;
an illumination angle adjustment mechanism configured to be capable of changing an irradiation direction of the illumination light with respect to an object; and
a stage on which a module is detachably loaded, the module including the object and an image sensor which are integrated such that the illumination light transmitted through the object is incident on the image sensor, the stage having a circuit for receiving an output of the image sensor in a state where the module is loaded on the stage.

2. The image acquisition device according to claim 1, wherein the illumination angle adjustment mechanism includes a mechanism capable of independently rotating at least one of orientations of the stage and the light source around two axes orthogonal to each other.

3. The image acquisition device according to claim 1, wherein the illumination angle adjustment mechanism includes a goniometer mechanism for changing at least one of an attitude of the stage and an orientation of the light source.

4. The image acquisition device according to claim 1, wherein the illumination angle adjustment mechanism includes a mechanism for rotating at least one of the stage and the light source with respect to a rotation axis passing through a center of the stage.

5. The image acquisition device according to claim 1, wherein the illumination angle adjustment mechanism includes a slide mechanism for parallel shifting of at least one of the stage, the light source, and the lens.

6. The image acquisition device according to claim 1, wherein the light source has at least one of sets each having a plurality of light emitting elements for emitting light of different wavelength bands from each other.

7. The image acquisition device according to claim 6, wherein the light source has a plurality of the sets arranged in different positions from each other.

8. The image acquisition device according to claim 6, wherein the lens is an achromatic lens.

9. The image acquisition device according to claim 1, wherein the stage has a first circuit board including a first processing circuit for converting an output of the image sensor into a digital signal and for outputting the digital signal.

10. The image acquisition device according to claim 9, wherein
the stage has a second circuit board including a second processing circuit for generating a control signal of the image sensor, and
the second circuit board is integrally coupled to the first circuit board.

11. The image acquisition device according to claim 1, further comprising a third processing circuit configured to successively perform an averaging process for an image signal representing an image of the object corresponding to the irradiation direction which is obtained in every time when the irradiation direction is changed.

12. An image formation system comprising:
the image acquisition device according to claim 1; and
an image processing device for forming a high resolution image of the object with resolution higher than resolution of each of a plurality of images of the object which are obtained by changing the irradiation direction of the illumination light, the image processing device forming the high resolution image by synthesizing the plurality of images.
